(19) United States
(12) Patent Application Publication
(10) Pub. No.: US 2021/0405872 A1
(43) Pub. Date: Dec. 30, 2021

(54) ELECTRONIC DEVICE, FLEXIBLE TOUCH DEVICE, AND STATE DETERMINING METHOD THEREOF

(71) Applicant: Shenzhen Royole Technologies Co., Ltd., Shenzhen (CN)

(72) Inventor: Jianpeng Li, Shenzhen (CN)

(21) Appl. No.: 17/410,185

(22) Filed: Aug. 24, 2021

Related U.S. Application Data
(63) Continuation of application No. PCT/CN2019/076020, filed on Feb. 25, 2019.

(51) Int. Cl. G06F 3/041; G06F 1/16; G06F 3/044

(52) U.S. Cl. CPC G06F 3/041662; G06F 2203/04102; G06F 3/0446; G06F 1/1652

(57) ABSTRACT

The present disclosure provides a flexible touch device. The flexible touch device includes a processor, transmit electrodes, and receive electrodes; wherein the processor is configured to acquire a self-capacitance of the receive electrode and a mutual capacitance between the transmit electrode and the receive electrode, and determine a current state of the flexible touch device based on variations of the self-capacitance and the mutual capacitance. The present disclosure further provides a state determining method and an electronic device.

### CROSS-REFERENCE TO RELATED APPLICATIONS

This application is a continuation of International Application No. PCT/CN2019/076020, with an international filing date of Feb. 25, 2019, titled “ELECTRONIC DEVICE, FLEXIBLE TOUCH DEVICE, AND STATE DETERMINING METHOD THEREOF”, the entire contents of which are incorporated herein by reference.

### TECHNICAL FIELD

The present disclosure relates to the technical field of flexible touch, and in particular, relates to an electronic device, a flexible touch device, and a state determining method thereof.

### BACKGROUND

With the development of capacitive touch technologies, more and more terminals are being equipped with a capacitive touch screen. The flexible capacitive touch screen technologies are also undergoing rapid development. However, when stretched, the flexible capacitive touch screen is subjected to elastic deformation, the area thereof increases, and the capacitance thereof varies. Where the external force is released, the elastic deformation disappears, and the capacitance varies again. In the conventional schemes of the capacitive touch screens, whether the flexible touch device is touched or not is determined based on variations of the capacitance.

### SUMMARY

The flexible touch device according to the embodiments of the present disclosure includes a processor, transmit electrodes, and receive electrodes; wherein the processor is configured to acquire a self-capacitance of the receive electrode and a mutual capacitance between the transmit electrode and the receive electrode, and determine a current state of the flexible touch device based on variations of the self-capacitance and the mutual capacitance.

The state determining method according to the embodiments of the present disclosure, applicable to a flexible touch device including transmit electrodes and receive electrodes, includes: acquiring a self-capacitance of the receive electrode and a mutual capacitance between the transmit electrode and the receive electrode; and determining a current state of the flexible touch device based on variations of the self-capacitance and the mutual capacitance.

The electronic device according to the embodiments of the present disclosure includes the flexible touch device. The flexible touch device includes a processor, transmit electrodes, and receive electrodes; wherein the processor is configured to acquire a self-capacitance of the receive electrode and a mutual capacitance between the transmit electrode and the receive electrode, and determine a current state of the flexible touch device based on variations of the self-capacitance and the mutual capacitance.

### BRIEF DESCRIPTION OF THE DRAWINGS

For clearer descriptions of technical solutions according to the embodiments of the present disclosure, drawings that are to be referred for description of the embodiments are briefly described hereinafter. Apparently, the drawings described hereinafter merely illustrate some embodiments of the present disclosure. Persons of ordinary skill in the art may also derive other drawings based on the drawings described herein without any creative effort.

FIG. 1 is a schematic diagram of modules of an electronic device according to an embodiment of the present disclosure;

FIG. 2 is a schematic circuit diagram of a self-capacitance of a receive electrode according to an embodiment of the present disclosure;

FIG. 3 is a schematic circuit diagram of a self-capacitance of a receive electrode upon stretching according to an embodiment of the present disclosure;

FIG. 4 is a schematic circuit diagram of a mutual capacitance between a receive electrode and a transmit electrode according to an embodiment of the present disclosure;

FIG. 5 is a schematic circuit diagram of a mutual capacitance between a receive electrode and a transmit electrode upon stretching according to an embodiment of the present disclosure;

FIG. 6 is a schematic circuit diagram of a self-capacitance of a receive electrode when a flexible touch device is touched according to an embodiment of the present disclosure;

FIG. 7 is a schematic circuit diagram of a self-capacitance between a receive electrode and a transmit electrode when a flexible touch device is touched according to an embodiment of the present disclosure;

FIG. 8 is a schematic circuit diagram of a flexible touch device according to an embodiment of the present disclosure;

FIG. 9 is a schematic circuit diagram of a flexible touch device according to an embodiment of the present disclosure; and

FIG. 10 is a schematic flowchart of a state determining method according to an embodiment of the present disclosure.

### DETAILED DESCRIPTION

The technical solutions contained in the embodiments of the present disclosure are described in detail clearly and completely hereinafter with reference to the accompanying drawings for the embodiments of the present disclosure. Apparently, the described embodiments are only a portion of embodiments of the present disclosure, but not all the embodiments of the present disclosure. Based on the embodiments of the present disclosure, all other embodiments derived by persons of ordinary skill in the art without any creative efforts shall fall within the protection scope of the present disclosure.

The terms “comprise,” “include,” and variations thereof in the specification, claims and accompanying drawings are intended to define a non-exclusive meaning. For example, a process, method, system, product, or device containing a series of steps or units is not limited to the listed steps or units, but optionally includes some other steps or units that are not listed, or optionally further includes other inherited steps or units of the process, method, product or device. Terms such as “first,” “second,” and the like in the specifications, claims and the accompanying drawings of the present invention are intended to distinguishing different objects but are not intended to define a specific sequence.

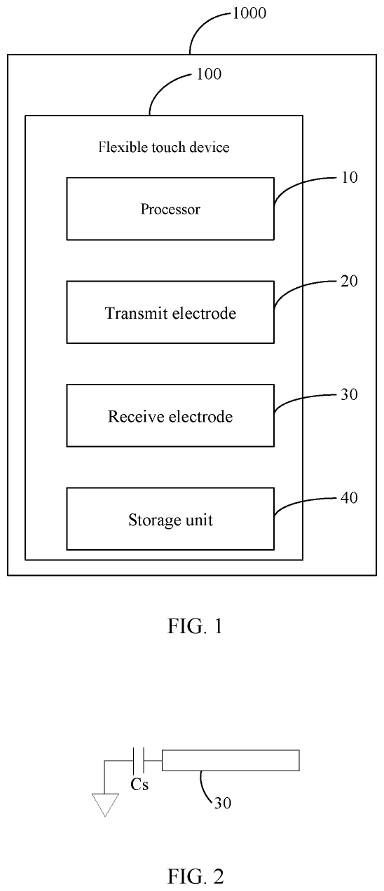

Referring to FIG. 1, FIG. 1 is a schematic diagram of modules of an electronic device 1000 according to an embodiment of the present disclosure. The electronic device 1000 may be, but not limited to, a mobile phone, a laptop computer, a tablet computer, an electronic reader, a personal digital assistant, a wearable electronic device, or the like. The electronic device 1000 includes a stretchable flexible touch device 100. In one embodiment, the flexible touch device 100 is a flexible touch screen.

The flexible touch device 100 includes a processor 10. The processor 10 may be a central processing unit (CPU), or may be a general purpose processor, a digital signal processor (DSP), an application specific integrated circuit (ASIC), a field-programmable gate array (FPGA), or a programmable logic device, a discrete gate or transistor logic device, a discrete hardware component, or the like. The general purpose processor may be a microprocessor or any customary processor or the like.

The flexible touch device 100 includes a transmit electrode 20 and a receive electrode 30. The flexible touch device 100 is fabricated with a stretchable material, wherein the transmit electrode 20 and the receive electrode 30 are also both stretchable electrodes. That is, these electrodes may be stretched under a tension force, and may naturally contract in case of release of an external force.

Capacitance variations caused by tensile deformation result in a misjudgment that the flexible touch device is touched. For prevention of the misjudgments, a current state of the flexible touch device needs to be detected first. However, in the related art, no method is provided as to how to detect the current state of the flexible touch device.

In the embodiments of the present disclosure, the processor 10 is configured to acquire a self-capacitance of the receive electrode 30 and a mutual capacitance between the transmit electrode 20 and the receive electrode 30, and determine a current state of the flexible touch device 100 based on variations of the self-capacitance and the mutual capacitance.

Specifically, the processor 10 is configured to scan the self-capacitance and the mutual capacitance of the transmit electrode 20 and the receive electrode 30. When the processor 10 is used to scanning the self-capacitance, the processor 10 scans the self-capacitance of the receive electrode 30. When the processor 10 is used to scanning the mutual capacitance, the processor 10 scans the mutual capacitance between the transmit electrode 20 and the receive electrode 30.

Determining the current state of the flexible touch device 100 based on the variations of the self-capacitance and the mutual capacitance includes at least one of the following processes:

in response to determining that the variations of the self-capacitance and the mutual capacitance of the flexible touch device 100 at the same position tend to be consistent, the processor 10 determines that the flexible touch device 100 is stretched or compressed; wherein specifically, in response to determining that the self-capacitance and the mutual capacitance of the flexible touch device 100 at the same position both increase, the processor 10 determines that the flexible touch device 100 is stretched;

in response to determining that the variations of the self-capacitance and the mutual capacitance of the flexible touch device 100 at the same position tend to be opposite, the processor 10 determines that the flexible touch device 100 is touched or released; wherein specifically, in response to determining that the self-capacitance of the flexible touch device 100 at the same position increases and the mutual capacitance of the flexible touch device 100 decreases, the processor 10 determines that the flexible touch device 100 is touched; and

in response to determining the self-capacitance of the flexible touch device 100 at the same position constantly increases and the mutual capacitance of the flexible touch device 100 increases first and then decreases, the processor 10 determines that the flexible touch device 100 is stretched first and then touched.

Specifically, determining the current state of the flexible touch device 100 based on the variations of the self-capacitance and the mutual capacitance includes the following process: the processor 10 compares an acquired self-capacitance at the same position within a current scanning period with a self-capacitance within a previous scanning period, compares an acquired mutual capacitance at the same position within the current scanning period with a mutual capacitance within the previous scanning period, and determines a current state of the flexible touch device 100 based on a result of comparison between the self-capacitance within the current scanning period and the self-capacitance within the previous scanning period and a result of comparison between the mutual capacitance within the current scanning period and the mutual capacitance within the previous scanning period. wherein the current state includes any one of states where the flexible touch device is touched, the flexible touch device is released, the flexible touch device is stretched, and the flexible touch device is contracted.

Specifically, referring to FIG. 2, a self-capacitance Cs of the receive electrode 30 is a capacitance formed between the receive electrode 30 and the ground. Referring to FIG. 3, when the receive electrode 30 is stretched and in a stretched state, according to equation C=εS/4πkd wherein C is a capacitance, c is a dielectric constant, each material has a fixed dielectric constant, S is an exact opposite area between two plates of a capacitor, d is a distance between the two plates of the capacitor, since the area of the receive electrode 30 in the stretched state increases relative to that in a natural state, a self-capacitance Cs' of the receive electrode 30 in the stretched state increases relative to the self-capacitance Cs in the natural state. On the contrary, when the receive electrode 30 is contracted from the stretched state, since the area of the receive electrode 30 when contracted decreases relative to the area thereof in the stretched state, the self-capacitance Cs of the receive electrode 30 when contracted decreases relative to the self-capacitance Cs' thereof in the stretched state.

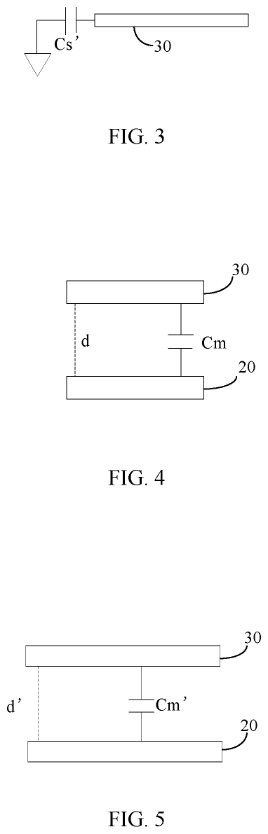

Specifically, referring to FIG. 4, a mutual capacitance Cm between the transmit electrode 20 and the receive electrode 30 is a capacitance between the transmit electrode 20 and the receive electrode 30 when the distance between the transmit electrode 20 and the receive electrode 30 is d. Referring to FIG. 5, when the transmit electrode 20 and the receive electrode 30 are wholly stretched, the areas of the transmit electrode 20 and the receive electrode 30 increase relative to those in the natural state before stretching. Although the dielectric constant ε of a commonly used substrate of a touch screen decreases with increase of a stretching magnification, the dielectric constant ε is changed by only several percent even if dozens of times of area deformation is generated due to the stretching, and thus the change of the dielectric constant ε is far less than the change of the area. In addition, the distance d between the transmit electrode 20 and the receive electrode 30 decreases. Therefore, similarly according to equation C=εS/4πkd, the mutual capacitance Cm′ between the transmit electrode 20 and the receive electrode 30 wholly in the stretched state increases relative to the mutual capacitance in the natural state. On the contrary, when the transmit electrode 20 and the receive electrode 30 are wholly contracted from the stretched state, since the areas of the transmit electrode 20 and the receive electrode 30 decrease relative to the areas in the stretched state, and the distance between the transmit electrode 20 and the receive electrode 30 increases, the mutual capacitance Cm between the transmit electrode 20 and the receive electrode 30 in the natural state decreases relative to the mutual capacitance Cm′ therebetween in the stretched state.

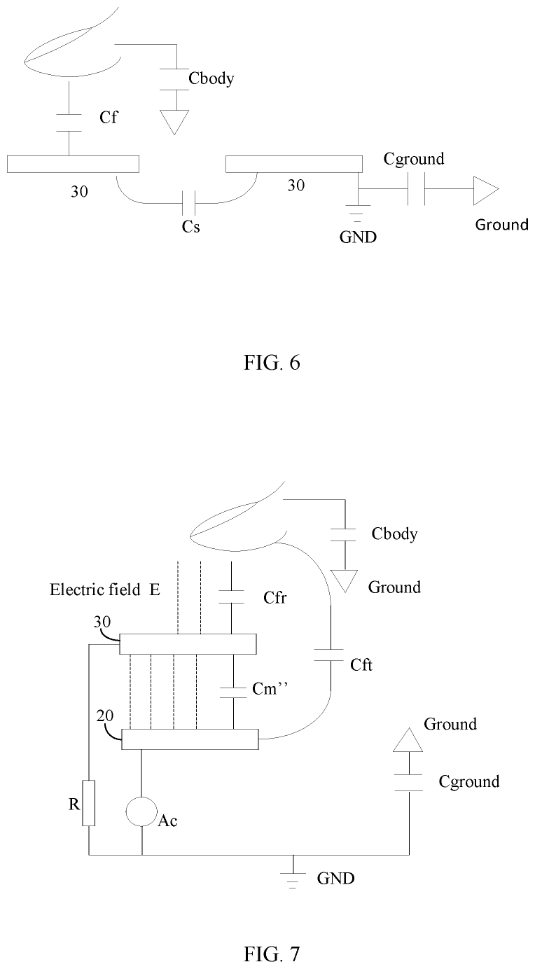

Referring to FIG. 6, when the receive electrode 30 is touched, a self-capacitance Cs″ of the receive electrode 30 includes the capacitance Cs formed between the receive electrode 30 and the ground and a capacitance Cf formed between the receive electrode 30 and a human body. The capacitance Cs formed between the receive electrode 30 and the ground is connected in parallel to the capacitance Cf formed between the receive electrode 30 and the human body. Therefore, when the receive electrode 30 is touched, the self-capacitance Cs″ of the receive electrode 30 increases. Specifically, a capacitance Cbody between the human body and the ground and a capacitance Cground between a device ground GND and the ground are sufficiently great, and the capacitance Cbody and the capacitance Cground have a small capacitive reactance against high-frequency alternating-current signals, which may even be ignored. Therefore, when the receive electrode 30 is touched, the self-capacitance Cs″ of the receive electrode 30 is formed by parallel connection between the capacitance Cs between the receive electrode 30 and the ground, and the capacitance Cf between the receive electrode 30 and the human body. That is, when the receive electrode 30 is touched, the self-capacitance Cs″ thereof increases relative to the self-capacitance Cs when the receive electrode 30 is not touched; and on the contrary, when the receive electrode 30 is released, the self-capacitance Cs of the receive electrode 30 decreases relative to the self-capacitance Cs″ thereof when the receive electrode 30 is touched. The term “released” means that the finger of a user leaves the receive electrode 30.

Referring to FIG. 7, when the mutual capacitance Cm is formed between the transmit electrode 20 and the receive electrode 30, and the receive electrode 30 is touched, an electric field between the transmit electrode 20 and the receive electrode 30 is partially transferred to the finger, a current originally flowing from the transmit electrode 20 to the receive electrode 30 is partially taken by a capacitance Cfr formed between the finger and the receive electrode 30 and a capacitance Cft formed between the finger and the transmit electrode 30, the current of the receive electrode 30 decreases relative to that of the receive electrode 30 when no touched, the capacitance Cbody between the human body and the ground and the capacitance Cground between the device ground GND and the ground are sufficiently great, and the capacitive reactance against the high-frequency alternating-current signal is small. Therefore, the capacitance Cbody and the capacitance Cground between the device ground GND and the ground may be ignored. Therefore, when the mutual capacitance Cm is formed between the transmit electrode 20 and the receive electrode 30, and the receive electrode 30 is touched, the capacitance between the transmit electrode 20 and the receive electrode 30 is equivalent to the mutual capacitance Cm″, which decreases relative to the mutual capacitance within the previous scanning period. On the contrary, when the mutual capacitance Cm is formed between the transmit electrode 20 and the receive electrode 30, and the receive electrode 30 is released, the capacitance between the transmit electrode 20 and the receive electrode 30 is equivalent to the mutual capacitance Cm″, which increases relative to the mutual capacitance within the previous scanning period.

Further, referring to FIG. 1, in one embodiment, the flexible touch device 100 further includes a storage unit 40. The storage unit 40 is electrically connected to the processor 10, and is configured to store the self-capacitance within the previous scanning period, and the mutual capacitance within the previous scanning period. The storage unit 40 may be configured to store computer programs and/or modules. In addition, the storage unit 40 may include a high-speed random-access memory, and may further include a non-volatile memory, for example, a hard disk, a memory, an external hard disk, a smart media card (SMC), a secure digital (SD) card, a flash card, a plurality of hard disk storage devices, flash devices, or other volatile solid storage devices.

Specifically, in one embodiment, the processor 10 determines the current state of the flexible touch device 100 as being touched, in response to determining that the self-capacitance within the current scanning period is greater than the self-capacitance within the previous scanning period and the mutual capacitance within the current scanning period is less than the mutual capacitance within the previous scanning period; or

Specifically, in one embodiment, the processor 10 determines the current state of the flexible touch device 100 as being released, in response to determining that the self-capacitance within the current scanning period is less than the self-capacitance within the previous scanning period and the mutual capacitance within the current scanning period is greater than the mutual capacitance within the previous scanning period.

Specifically, in one embodiment, the processor 10 determines the current state of the flexible touch device 100 as being stretched, in response to determining that the self-capacitance within the current scanning period is greater than the self-capacitance within the previous scanning period and the mutual capacitance within the current scanning period is greater than the mutual capacitance within the previous scanning period.

Specifically, in one embodiment, the processor 10 determines the current state of the flexible touch device 100 as being contracted, in response to determining that the self-capacitance within the current scanning period is less than the self-capacitance within the previous scanning period and the mutual capacitance within the current scanning period is less than the mutual capacitance within the previous scanning period.

Further, in one embodiment, the processor 10 determines the current state of the flexible touch device 100 as being touched, in response to determining that the self-capacitance within the current scanning period is greater than the self-capacitance within the previous scanning period and a difference between the two self-capacitances exceeds a capacitance variation threshold, and the mutual capacitance within the current scanning period is less than the mutual capacitance within the previous scanning period and a difference between the two mutual capacitances exceeds the capacitance variation threshold.

Further, in one embodiment, the processor 10 regulates the capacitance variation threshold for touch sensing determination in response to the flexible touch device being touched, based on a self-capacitance ratio of a self-capacitance upon a physical variation when the flexible touch device 100 is stretched or contracted to an initial self-capacitance, and/or a mutual capacitance ratio of a mutual capacitance upon a physical variation when the flexible touch device 100 is stretched or contracted to an initial mutual capacitance, and stores the capacitance variation threshold to the storage unit 40. It may be understood that when the storage unit 40 is configured to store the capacitance variation threshold, the capacitance variation threshold is stored in a non-volatile memory of the storage unit 40. The initial self-capacitance refers to a self-capacitance of the receive electrode 30 set before delivery of the electronic device 1000 from factory, and the initial mutual capacitance refers to a mutual capacitance between the transmit electrode 20 and the receive electrode 30 set before delivery of the electronic device 1000 from factory. The regulation of the capacitance variation threshold for touch sensing in response to the flexible touch device being touched occurs each time the flexible touch device is stretched or contracted, such that the capacitance variation threshold is refreshed where the physical changes occur to the flexible touch device 100, thereby preventing the situation where the capacitance variations caused by the physical changes affect the sensitivity of the flexible touch device 100.

Specifically, in one embodiment, the storage unit 40 of the flexible touch device 100 pre-stores a corresponding relationship table between the self-capacitance ratio and/or the mutual capacitance ratio and the capacitance variation threshold. The processor 10 determines a corresponding capacitance variation threshold based on the self-capacitance ratio and/or the mutual capacitance ratio, and regulates a current capacitance variation threshold to the determined corresponding capacitance variation threshold to regulate sensitivity of touch sensing. To be specific, when the capacitance variations fall within the capacitance variation threshold, the processor 10 determines that the flexible touch device is touched and makes a response, and otherwise, the flexible touch device does not make a response. As such, sensitivity of touch sensing is effectively regulated, and the situation where the touch sensing is over sensitive or not sensitive is prevented.

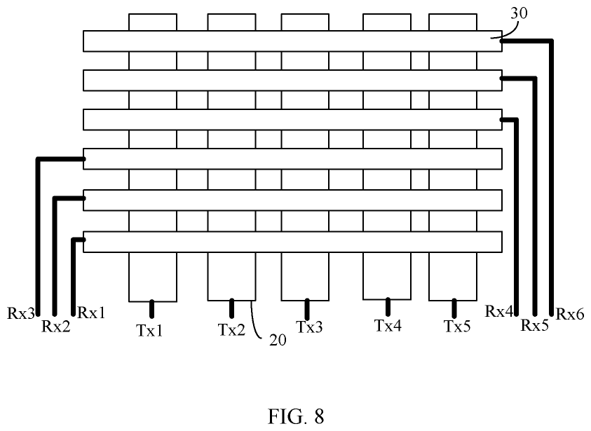

Specifically, in one embodiment, the transmit electrodes 20 include n columns of transmit electrodes 20, and the receive electrodes 30 include m rows of receive electrodes 30. The n columns of transmit electrodes 20 and the m rows of receive electrodes 30 are crosswise arranged. For example, referring to FIG. 8 as well, the n columns of transmit electrodes 20 include a first transmit electrode Tx1, a second transmit electrode Tx2, a third transmit electrode Tx3, a fourth transmit electrode Tx4, and a fifth transmit electrode Tx5. Them rows of receive electrodes 30 include a first receive electrode Rx1, a second receive electrode Rx2, a third receive electrode Rx3, a fourth receive electrode Rx4, a fifth receive electrode Rx5, and a sixth receive electrode Rx6. The first transmit electrode Tx1, the second transmit electrode Tx2, the third transmit electrode Tx3, the fourth transmit electrode Tx4, and the fifth transmit electrode Tx5 are crosswise arranged with the first receive electrode Rx1, the second receive electrode Rx2, the third receive electrode Rx3, the fourth receive electrode Rx4, the fifth receive electrode Rx5, and the sixth receive electrode Rx6.

Specifically, in one embodiment, the processor 10 alternately scans the self-capacitance and the mutual capacitance for each row of receive electrodes 30, and in response to scanning the self-capacitance of one row of receive electrodes 30, controls the transmit electrodes 20 corresponding to the row of receive electrodes 30 to be grounded or suspended.

Specifically, referring to FIG. 8, in one embodiment, the n columns of transmit electrodes 20 are arranged on a first substrate, the m rows of receive electrodes 30 are arranged on a second substrate, and the n columns of transmit electrodes 20 and the m rows of receive electrodes 30 are spaced apart.

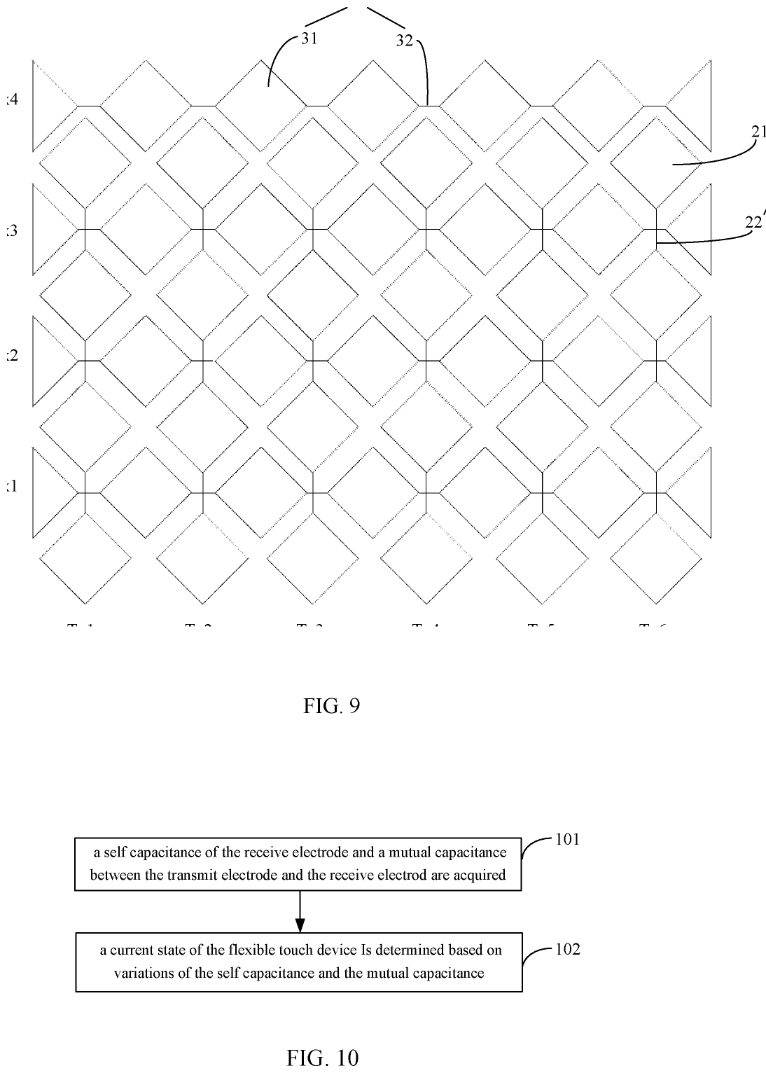

Specifically, referring to FIG. 9, in one embodiment, the n columns of transmit electrodes 20 and the m rows of receive electrodes 30 are arranged on the same substrate, wherein each column of transmit electrodes 20 includes a plurality of transmit electrode units 21 and a plurality of first connecting lines 22. The plurality of transmit electrode units 21 are arranged along a first direction, and adjacent transmit electrode units 21 are connected via the first connecting lines 22. Each row of receive electrodes 30 includes a plurality of receive electrode units 31 and a plurality of second connecting lines 32. The plurality of receive electrode units 31 are arranged along a second direction, and adjacent receive electrode units 31 are connected via the second connecting lines 32. The first connecting line 22 and the second connecting line 32 are crosswise arranged, and the first connecting line 22 and the second connecting line 32 are insulated from each other at the cross. Preferably, the first direction is perpendicular to the second direction.

Referring to FIG. 10, FIG. 10 is a flowchart of a state determining method according to an embodiment of the present disclosure. The state determining method is applicable to the flexible touch device 100 as described above. The flexible touch device 100 includes a transmit electrode 20 and a receive electrode 30. It may be understood that execution of steps of the state determining method is not limited to the sequence as illustrated in FIG. 10. Specifically, the state determining method includes the following steps:

In step 101, a self-capacitance of the receive electrode 30 and a mutual capacitance between the transmit electrode 20 and the receive electrode 30 are acquired.

Specifically, the processor 10 is configured to scan the self-capacitance and the mutual capacitance of the transmit electrode 20 and the receive electrode 30. When the processor 10 is used to scanning the self-capacitance, the processor 10 scans the self-capacitance of the receive electrode 30. When the processor 10 is used to scanning the mutual capacitance, the processor 10 scans the mutual capacitance between the transmit electrode 20 and the receive electrode 30.

In step 102, a current state of the flexible touch device is determined based on variations of the self-capacitance and the mutual capacitance.

Determining the current state of the flexible touch device 100 based on the variations of the self-capacitance and the mutual capacitance includes at least one of the following processes:

in response to determining that the variations of the self-capacitance and the mutual capacitance of the flexible touch device 100 at the same position tend to be consistent, the processor 10 determines that the flexible touch device 100 is stretched or compressed; wherein specifically, in response to determining that the self-capacitance and the mutual capacitance of the flexible touch device 100 at the same position both increase, the processor 10 determines that the flexible touch device 100 is stretched;

in response to determining that the variations of the self-capacitance and the mutual capacitance of the flexible touch device 100 at the same position tend to be opposite, the processor 10 determines that the flexible touch device 100 is touched or released; wherein specifically, in response to determining that the self-capacitance of the flexible touch device 100 at the same position increases and the mutual capacitance of the flexible touch device 100 decreases, the processor 10 determines that the flexible touch device 100 is touched; and

in response to determining the self-capacitance of the flexible touch device 100 at the same position constantly increases and the mutual capacitance of the flexible touch device 100 at the same position increases first and then decreases, the processor 10 determines that the flexible touch device 100 is stretched first and then touched.

Specifically, determining the current state of the flexible touch device 100 based on the variations of the self-capacitance and the mutual capacitance includes:

respectively comparing a self-capacitance and a mutual capacitance within a current scanning period that are acquired at the same position with a self-capacitance and a mutual capacitance within a previous scanning period, and determining a current state of the flexible touch device 100 based on a result of comparison between the self-capacitance within the current scanning period and the self-capacitance within the previous scanning period and a result of comparison between the mutual capacitance within the current scanning period and the mutual capacitance within the previous scanning period; wherein the current state includes any one of states where the flexible touch device is touched, the flexible touch device is released, the flexible touch device is stretched, and the flexible touch device is contracted.

Specifically, determining the current state of the flexible touch device 100 based on the result of comparison between the self-capacitance within the current scanning period and the self-capacitance within the previous scanning period and the result of comparison between the mutual capacitance within the current scanning period and the mutual capacitance within the previous scanning period includes:

determining the current state of the flexible touch device 100 as being touched, in response to determining that the self-capacitance within the current scanning period is greater than the self-capacitance within the previous scanning period and the mutual capacitance within the current scanning period is less than the mutual capacitance within the previous scanning period; or

determining the current state of the flexible touch device 100 as being released, in response to determining that the self-capacitance within the current scanning period is less than the self-capacitance within the previous scanning period and the mutual capacitance within the current scanning period is greater than the mutual capacitance within the previous scanning period; or

determining the current state of the flexible touch device 100 as being stretched, in response to determining that the self-capacitance within the current scanning period is greater than the self-capacitance within the previous scanning period and the mutual capacitance within the current scanning period is greater than the mutual capacitance within the previous scanning period; or

determining the current state of the flexible touch device 100 as being contracted, in response to determining that the self-capacitance within the current scanning period is less than the self-capacitance within the previous scanning period and the mutual capacitance within the current scanning period is less than the mutual capacitance within the previous scanning period.

Specifically, in one embodiment, the state determining method further includes:

determining the current state of the flexible touch device 100 as being touched, in response to determining that the self-capacitance within the current scanning period is greater than the self-capacitance within the previous scanning period and a difference between the two self-capacitances exceeds a capacitance variation threshold, and the mutual capacitance within the current scanning period is less than the mutual capacitance within the previous scanning period and a difference between the two mutual capacitances exceeds the capacitance variation threshold.

Specifically, in one embodiment, the state determining method further includes:

regulating the capacitance variation threshold for touch sensing determination in response to the flexible touch device being touched, based on a self-capacitance ratio of a self-capacitance upon a physical variation when the flexible touch device is stretched or contracted to an initial self-capacitance, and/or a mutual capacitance ratio of a mutual capacitance upon a physical variation when the flexible touch device 100 is stretched or contracted to an initial mutual capacitance. The initial self-capacitance refers to a self-capacitance of the receive electrode 30 set before delivery of the electronic device 1000 from factory, and the initial mutual capacitance refers to a mutual capacitance between the transmit electrode 20 and the receive electrode 30 set before delivery of the electronic device 1000 from factory. It may be understood that the regulation of the capacitance variation threshold for touch sensing in response to the flexible touch device being touched occurs each time the flexible touch device is stretched or contracted, such that the capacitance variation threshold is refreshed where the physical changes occur to the flexible touch device 100, thereby preventing the situation where the capacitance variations caused by the physical changes affect the sensitivity of the flexible touch device 100.

Specifically, in one embodiment, the storage unit 40 of the flexible touch device 100 pre-stores a corresponding relationship table between the self-capacitance ratio and/or the mutual capacitance ratio and the capacitance variation threshold for touch sensing determination, and the method further includes:

determining a corresponding capacitance variation threshold based on the self-capacitance ratio and/or the mutual capacitance ratio, and regulating a current capacitance variation threshold to the determined corresponding capacitance variation threshold to regulate sensitivity of touch sensing. To be specific, when the capacitance variations fall within the capacitance variation threshold, the processor 10 determines that the flexible touch device is touched and makes a response, and otherwise, the flexible touch device does not make a response. As such, sensitivity of touch sensing is effectively regulated, and the situation where the touch sensing is over sensitive or not sensitive is prevented.

Specifically, in one embodiment, the transmit electrodes 20 include n columns of transmit electrodes 20, and the receive electrodes 30 include m rows of receive electrodes 30. The n columns of transmit electrodes 20 and the m rows of receive electrodes 30 are crosswise arranged. Step 101 and step 102 further include:

alternately scanning the self-capacitance and the mutual capacitance for each row of receive electrodes 30, and in response to scanning the self-capacitance of one row of receive electrodes 30, controlling the transmit electrodes 20 corresponding to the row of receive electrodes 30 to be grounded or suspended.

In the electronic device, the flexible touch device, and the state determining method according to the present disclosure, the processor 10 is configured to acquire a self-capacitance of the receive electrode 30 and a mutual capacitance between the transmit electrode 20 and the receive electrode 30, and determine a current state of the flexible touch device 100 based on variations of the self-capacitance and the mutual capacitance. wherein the current state includes any one of states where the flexible touch device is touched, the flexible touch device is released, the flexible touch device is stretched, and the flexible touch device is contracted. As such, the current state of the flexible touch device 100 is correctly identified, and misjudgments due to the capacitance variations caused by stretching are prevented.

It should be noted that, with respect to the above described method embodiments, for brevity of description, the actions or steps are all described as a series of action combinations. However, a person skilled in the art shall understand that the embodiments of the present disclosure are not subjected to limitations of the action sequences described above. Further, based on the embodiments of the present disclosure, some steps may be performed in another or other sequences or may be simultaneously performed. In addition, a person skilled in the art should also know that the embodiments described in the description herein are all preferred embodiments, and all the involved actions and modules are not mandatory ones of the embodiments of the present disclosure.

In the above embodiments, descriptions give different particular emphases to various embodiments, and the portion of some embodiment that is not described may be referenced to the relevant description in other embodiments.

The steps in the method according to the embodiments of the present disclosure may be adjusted in sequence, may be combined, and may be deleted according to the actual needs.

Persons of ordinary skill in the art may understand that all or part of the steps of the methods in the embodiments may be implemented by a program instructing relevant hardware. The program may be stored in a computer readable storage medium and may be executed by at least one processor. When the program runs, the steps of the methods in the embodiments are performed. The storage medium may be any medium capable of storing program codes, such as a magnetic disk, a compact disc read-only memory (CD-ROM), a read-only memory (ROM), or a random-access memory (RAM).

The embodiments of the present disclosure are described hereinafter in detail. The principles and embodiments of the present disclosure have been described with reference to specific examples, and the above embodiments are described only to help understanding of the method and core idea of the present disclosure. Persons of ordinary skill in the art may make modification or variations to the specific embodiments or application scopes according to the inventive concept ofthe present disclosure. In conclusion, this specification shall not be understood as limiting the present disclosure.

What is claimed is:

1. A stretchable flexible touch device, comprising a processor, transmit electrodes, and receive electrodes; wherein the processor is configured to acquire a self-capacitance of the receive electrode and a mutual capacitance between the transmit electrode and the receive electrode, and determine a current state of the flexible touch device based on variations of the self-capacitance and the mutual capacitance.

2. The flexible touch device according to claim 1, wherein in response to determining that the variations of the self-capacitance and the mutual capacitance of the flexible touch device at the same position tend to be consistent, the processor is further configured to determine that the flexible touch device is stretched or compressed; or,
in response to determining that the variations of the self-capacitance and the mutual capacitance of the flexible touch device at the same position tend to be opposite, the processor is further configured to determine that the flexible touch device is touched or released.

3. The flexible touch device according to claim 2, wherein in response to determining that the self-capacitance and the mutual capacitance of the flexible touch device at the same position both increase, the processor is further configured to determine that the flexible touch device is stretched; or, in response to determining that the self-capacitance of the flexible touch device increases and the mutual capacitance of the flexible touch device at the same position decreases, the processor is further configured to determine that the flexible touch device is touched; or,
in response to determining that the self-capacitance of the flexible touch device constantly increases and the mutual capacitance of the flexible touch device at the same position increases first and then decreases, the processor is further configured to determine that the flexible touch device is stretched first and then touched.

4. The flexible touch device according to claim 1, wherein determining the current state of the flexible touch device based on the variations of the self-capacitance and the mutual capacitance comprises: determining a current state of the flexible touch device based on a result of comparison between the self-capacitance within a current scanning period and the self-capacitance within a previous scanning period and a result of comparison between the mutual capacitance within the current scanning period and the mutual capacitance within the previous scanning period; wherein the current state comprises any one of states where the flexible touch device is touched, the flexible touch device is released, the flexible touch device is stretched, and the flexible touch device is contracted.

5. The flexible touch device according to claim 4, wherein the processor is configured to determine the current state of the flexible touch device as being stretched, in response to determining that the self-capacitance within the current scanning period is greater than the self-capacitance within the previous scanning period and the mutual capacitance within the current scanning period is greater than the mutual capacitance within the previous scanning period; or
the processor is configured to determine that the current state of the flexible touch device as being contracted, in response to determining that the self-capacitance within the current scanning period is less than the self-capacitance within the previous scanning period and the mutual capacitance within the current scanning period is less than the mutual capacitance within the previous scanning period.

6. The flexible touch device according to claim 4, wherein the processor is configured to determine the current state of the flexible touch device as being touched, in response to determining that the self-capacitance within the current scanning period is greater than the self-capacitance within the previous scanning period and the mutual capacitance within the current scanning period is less than the mutual capacitance within the previous scanning period; or the processor is configured to determine that the current state of the flexible touch device as being released, in response to determining that the self-capacitance within the current scanning period is less than the self-capacitance within the previous scanning period and the mutual capacitance within the current scanning period is greater than the mutual capacitance within the previous scanning period.

7. The flexible touch device according to claim 6, wherein the processor is configured to determine the current state of the flexible touch device as being touched, in response to determining that the self-capacitance within the current scanning period is greater than the self-capacitance within the previous scanning period and a difference between the two self-capacitances exceeds a capacitance variation threshold, and the mutual capacitance within the current scanning period is less than the mutual capacitance within the previous scanning period and a difference between the two mutual capacitances exceeds the capacitance variation threshold.

8. The flexible touch device according to claim 7, wherein the processor is configured to regulate the capacitance variation threshold for touch sensing determination in response to the flexible touch device being touched, based on a self-capacitance ratio of a self-capacitance upon a physical variation when the flexible touch device is stretched or contracted to an initial self-capacitance, or a mutual capacitance ratio of a mutual capacitance upon a physical variation when the flexible touch device is stretched or contracted to an initial mutual capacitance.

9. The flexible touch device according to claim 8, wherein the flexible touch device pre-stores a corresponding relationship table between the self-capacitance ratio or the mutual capacitance ratio and the capacitance variation threshold, and the processor is configured to determine a corresponding capacitance variation threshold based on the self-capacitance ratio or the mutual capacitance ratio, and regulate a current capacitance variation threshold to the determined corresponding capacitance variation threshold.

10. A state determining method, applicable to a stretchable flexible touch device, the flexible touch device comprising transmit electrodes and receive electrodes, the method comprising:
a self-capacitance of the receive electrode and a mutual capacitance between the transmit electrode and the receive electrode are acquired; and
a current state of the flexible touch device is determined based on variations of the self-capacitance and the mutual capacitance.

11. The method according to claim 10, wherein the current state of the flexible touch device is determined based on the variations of the self-capacitance and the mutual capacitance comprises:
determining that the flexible touch device is stretched or compressed, in response to determining that the variations of the self-capacitance and the mutual capacitance of the flexible touch device at the same position tend to be consistent; or
determining that the flexible touch device is touched or released, in response to determining that the variations of the self-capacitance and the mutual capacitance of the flexible touch device at the same position tend be to be opposite.

12. The method according to claim 10, wherein the current state of the flexible touch device is determined based on the variations of the self-capacitance and the mutual capacitance comprises:
determining that the flexible touch device is stretched, in response to determining that the self-capacitance and the mutual capacitance of the flexible touch device at the same position both increase;
or
determining that the flexible touch device is touched, in response to determining that the self-capacitance of the flexible touch device increases and the mutual capacitance of the flexible touch device at the same position decreases; or
determining that the flexible touch device is stretched first and then touched, in response to determining that the self-capacitance of the flexible touch device constantly increases and the mutual capacitance of the flexible touch device at the same position increases first and then decreases.

13. The method according to claim 10, wherein the current state of the flexible touch device is determined based on the variations of the self-capacitance and the mutual capacitance comprises:
determining a current state of the flexible touch device based on a result of comparison between the self-capacitance within a current scanning period and the self-capacitance within a previous scanning period and a result of comparison between the mutual capacitance within the current scanning period and the mutual capacitance within the previous scanning period; wherein the current state comprises any one of states where the flexible touch device is touched, the flexible touch device is released, the flexible touch device is stretched, and the flexible touch device is contracted.

14. The method according to claim 13, wherein determining the current state of the flexible touch device based on the result of comparison between the self-capacitance within the current scanning period and the self-capacitance within the previous scanning period and the result of comparison between the mutual capacitance within the current scanning period and the mutual capacitance within the previous scanning period comprises:
determining the current state of the flexible touch device as being stretched, in response to determining that the self-capacitance within the current scanning period is greater than the self-capacitance within the previous scanning period and the mutual capacitance within the current scanning period is greater than the mutual capacitance within the previous scanning period; or
determining the current state of the flexible touch device as being contracted, in response to determining that the self-capacitance within the current scanning period is less than the self-capacitance within the previous scanning period and the mutual capacitance within the current scanning period is less than the mutual capacitance within the previous scanning period.

15. The method according to claim 13, wherein determining the current state of the flexible touch device based on the result of comparison between the self-capacitance within the current scanning period and the self-capacitance within the previous scanning period and the result of comparison between the mutual capacitance within the current scanning period and the mutual capacitance within the previous scanning period comprises:
determining the current state of the flexible touch device as being touched, in response to determining that the self-capacitance within the current scanning period is greater than the self-capacitance within the previous scanning period and the mutual capacitance within the current scanning period is less than the mutual capacitance within the previous scanning period; or
determining the current state of the flexible touch device as being released, in response to determining that the self-capacitance within the current scanning period is less than the self-capacitance within the previous scanning period and the mutual capacitance within the current scanning period is greater than the mutual capacitance within the previous scanning period.

16. The method according to claim 15, wherein determining the current state of the flexible touch device as being touched, in response to determining that the self-capacitance within the current scanning period is greater than the self-capacitance within the previous scanning period and the mutual capacitance within the current scanning period is less than the mutual capacitance within the previous scanning period comprises:
determining the current state of the flexible touch device as being touched, in response to determining that the self-capacitance within the current scanning period is greater than the self-capacitance within the previous scanning period and a difference between the two self-capacitances exceeds a capacitance variation threshold, and the mutual capacitance within the current scanning period is less than the mutual capacitance within the previous scanning period and a difference between the two mutual capacitances exceeds the capacitance variation threshold.

17. The method according to claim 16, further comprising:
regulating the capacitance variation threshold for touch sensing determination in response to the flexible touch device being touched, based on a self-capacitance ratio of a self-capacitance upon a physical variation when the flexible touch device is stretched or contracted to an initial self-capacitance, or a mutual capacitance ratio of a mutual capacitance upon a physical variation when the flexible touch device is stretched or contracted to an initial mutual capacitance.

18. The method according to claim 16, wherein the flexible touch device pre-stores a corresponding relationship table between the self-capacitance ratio or the mutual capacitance ratio and the capacitance variation threshold, and the method further comprises:
determining, based on the self-capacitance ratio or the mutual capacitance ratio, a corresponding capacitance variation threshold from the corresponding relationship table between the self-capacitance ratio or the mutual capacitance ratio and the capacitance variation threshold, and regulating a current capacitance variation threshold to the determined corresponding capacitance variation threshold.

19. The method according to claim 11, wherein the transmit electrodes comprise n columns of transmit electrodes, and the receive electrodes comprise m rows of receive electrodes, the n columns of transmit electrodes and the m rows of receive electrodes being crosswise arranged, wherein the self-capacitance of the receive electrode and the mutual capacitance between the transmit electrode and the receive electrode are acquired further comprises:
alternately scanning the self-capacitance and the mutual capacitance for each row of receive electrodes, and in response to scanning the self-capacitance of one row of receive electrodes, controlling the transmit electrodes corresponding to the row of receive electrodes to be grounded or suspended.

20. An electronic device, comprising a flexible touch device, the flexible touch device comprising a processor, transmit electrodes, and receive electrodes; wherein the processor is configured to acquire a self-capacitance of the receive electrode and a mutual capacitance between the transmit electrode and the receive electrode, and determine a current state of the flexible touch device based on variations of the self-capacitance and the mutual capacitance.
